(19) United States
(12) Patent Application Publication
(10) Pub. No.: US 2007/0257089 A1
(43) Pub. Date: Nov. 8, 2007

(54) Method for manufacturing spoke of diverse diameters

(75) Inventor: Wen-Hsuan Chen, Shulin City (TW)

Correspondence Address: TROXELL LAW OFFICE PLLC, SUITE 1404, 5205 LEESBURG PIKE, FALLS CHURCH, VA, 22041, US

(73) Assignee: Sha-Dar Accessories Co., Ltd.

(21) Appl. No.: 11/416,230

(22) Filed: May 3, 2006

(51) Int. Cl. B23K 1/20; B23K 31/00

(52) U.S. Cl. 228/173.1

(57) ABSTRACT

A method for manufacturing a spoke with diverse diameters is disclosed. A wire is drawn, and at least two rollers sequentially press the wire to form diverse diameters with circular, oval or flat cross section. A multi-layer spoke with diverse diameters and good roundness is achieved. This method is efficient and reduces manufacturing cost.

### BACKGROUND OF THE INVENTION

(a) Field of the Invention

The present invention relates to a method for manufacturing a spoke with different diameters.

(b) Description of the Prior Art

In prior art, multi-layer bicycle spokes with diverse diameters are manufactured by means of forging wires of predetermined diameter and length with mould sets. This manufacture method has the following disadvantages:

(1) high power consumption. No matter heat forging or cold forging, a very heavy forging machine is needed to forge wires frequently, consuming high power.

(2) apt to be heated. Mould sets and wires may be heated for friction and stamping, which influences tolerance of workpieces of spokes. The workpieces of spokes have to be cooled.

(3) low frequency. Spoke wires of different diameters need to be forged frequently by different mould sets, increasing time for replacing mould sets and decreasing production frequency.

(4) high production cost. During mould sets work, immense impact force may damage mould sets rapidly.

### SUMMARY OF THE INVENTION

Accordingly, an object of the present invention is to provide a method for manufacturing a spoke with different diameters and good roundness, where the method is efficient and reduces manufacturing cost.

The method for manufacturing a spoke with different diameters comprises the following steps:

a) placing a wire. A first clamp and a second clamp respectively position ends of a wire, and exert appropriate tension to the wire for allowing the wire to extend freely. A load meter is provided on the first clamp for sustaining the wire under strain of fixed tension. A controlling device is provided on the second clamp for controlling starting point and ending point of pressing.

b) pressing for shaping. At least two rollers are provided to move horizontally along the wire and press the wire according to desired diverse diameters to form diverse diameters with circular, oval or flat cross section on the wire. Each roller includes an upper wheel, a lower wheel, a left wheel and a right wheel. The upper wheel, the lower wheel, the left wheel and the right wheel respectively defines an upper groove, a lower groove, a left groove and a right groove around rims thereof. The upper wheel, the lower wheel, the left wheel and the right wheel adjust distance therebetween to form diverse diameters with circular, oval or flat cross section on the wire.

c) cutting. The wire is cut in accordance with desired length after pressing.

### BRIEF DESCRIPTION OF THE DRAWINGS

FIG. 1 is a flow chart of a method for manufacturing a spoke with different diameters according to the present invention.

FIG. 2 schematically shows a spoke with different diameters is being manufactured according to the method of manufacturing of the present invention.

FIGS. 3A-3D are sketch views of manufacturing a spoke with diverse diameters of 2.3 mm/2.0 mm/1.8 mm/1.6 mm/1.8 mm/2.0 mm/2.3 mm according to a first embodiment of the present invention.

FIGS. 4A and 4B are sketch views of manufacturing a spoke with diverse diameters of 2.3 mm/1.6 mm/2.0 mm/2.3 mm according to a second embodiment of the present invention.

FIGS. 5A-5D are sketch views of manufacturing a spoke with flat cross section according to a third embodiment of the present invention.

### DETAILED DESCRIPTION OF THE PREFERRED EMBODIMENTS

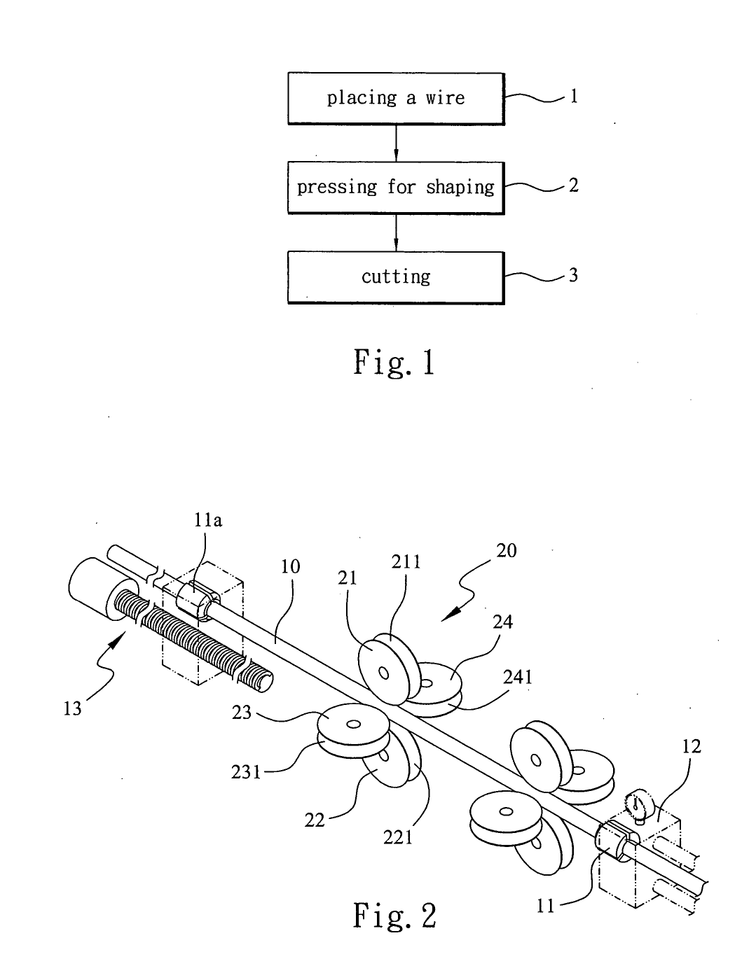

A method for manufacturing a spoke with different diameters in accordance with the present invention includes drawing a wire and pressing the wire sequentially by at least two rollers to form different diameters on the wire. The method for manufacturing a spoke with different diameters comprises at least three steps: placing a wire 1, pressing for shaping 2 and cutting 3, as shown in FIG. 1. A wire is drawn and pressed by at least two rollers to form circular, oval or flat cross section, thereby achieving a multi-layer spoke with diverse diameters which has good roundness. This method is efficient and reduces manufacturing cost. In detail, combining with FIGS. 1 and 2, the method of the present invention comprises the following steps:

a) placing a wire 1. A first clamp 11 and a second clamp 11a respectively position two ends of a wire 10, and exert appropriate tension to the wire 10 for allowing the wire 10 to extend freely. A load meter 12 is provided on the first clamp 11 for sustaining the wire 10 under strain of fixed tension. A controlling device 13 is provided on the second clamp 11a for controlling starting point and ending point of pressing. Preferably, the controlling device 13 is a servo motor.

b) pressing for shaping 2. At least two rollers are provided to move horizontally along the wire 10 and press the wire 10 according to desired diverse diameters. Each roller 20 includes an upper wheel 21, a lower wheel 22, a left wheel 23 and a right wheel 24 which cooperate with a cam (not shown) to open or close. The upper wheel 21, the lower wheel 22, the left wheel 23 and the right wheel 24 respectively defines an upper groove 211, a lower groove 221, a left groove 231 and a right groove 241 around rims thereof. The upper wheel 21, the lower wheel 22, the left wheel 23 and the right wheel 24 may be selectively arranged or adjust distance therebetween to form circular, oval or flat cross section on a common wire 10.

c) cutting 3. The wire 10 is cut in accordance with desired length after pressing.

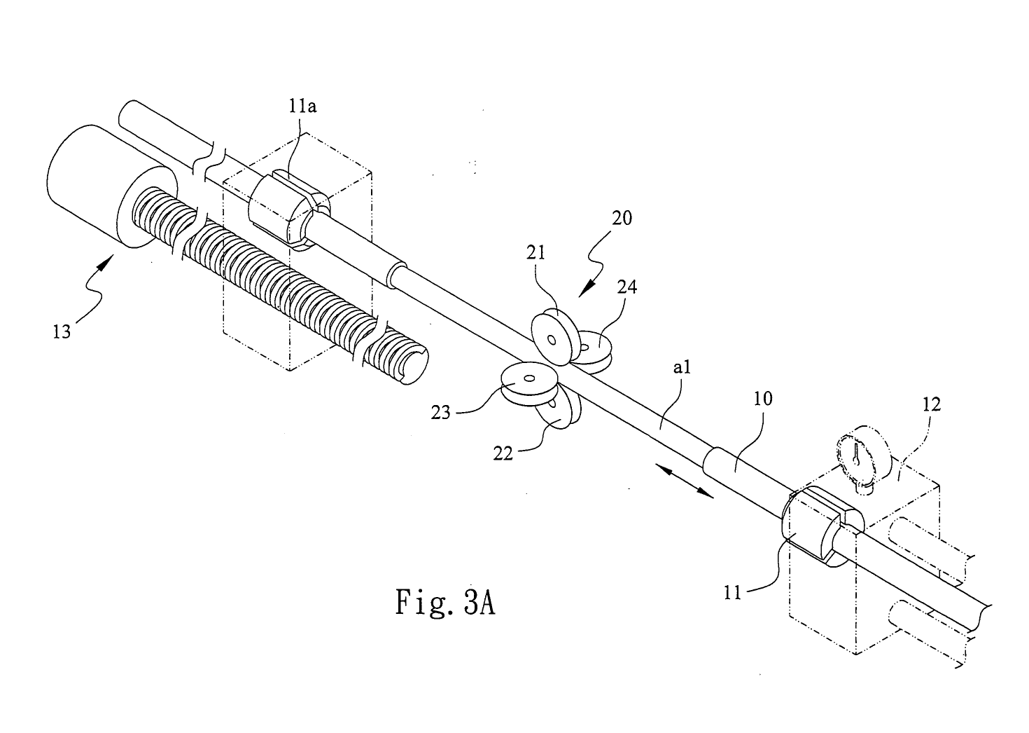

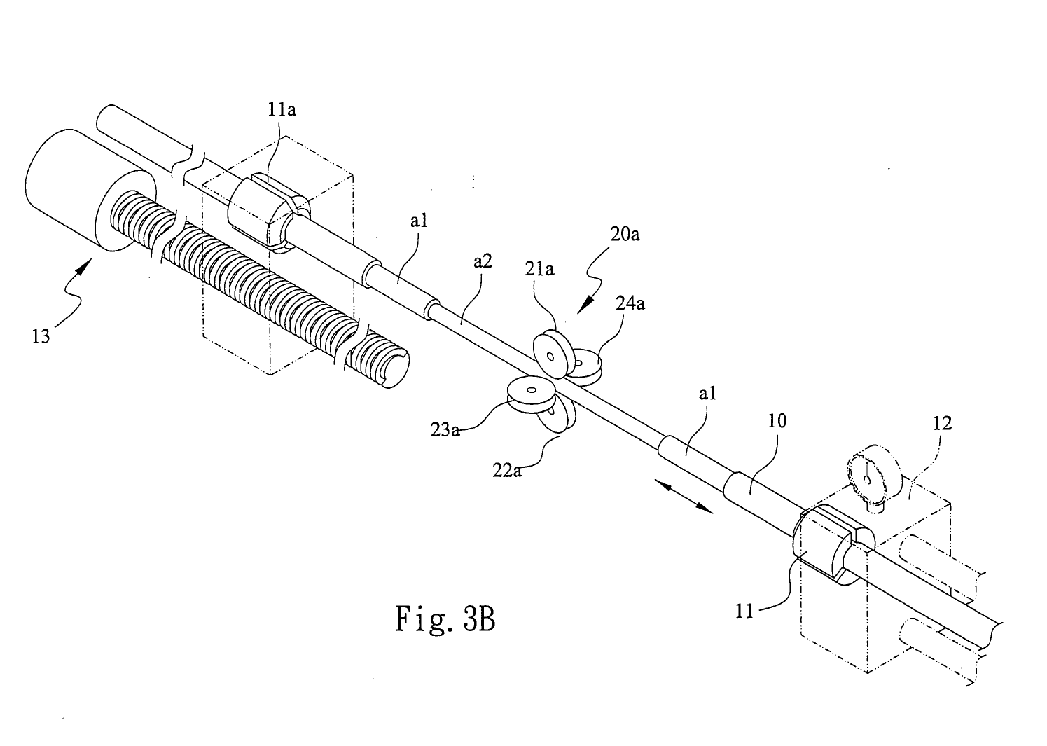

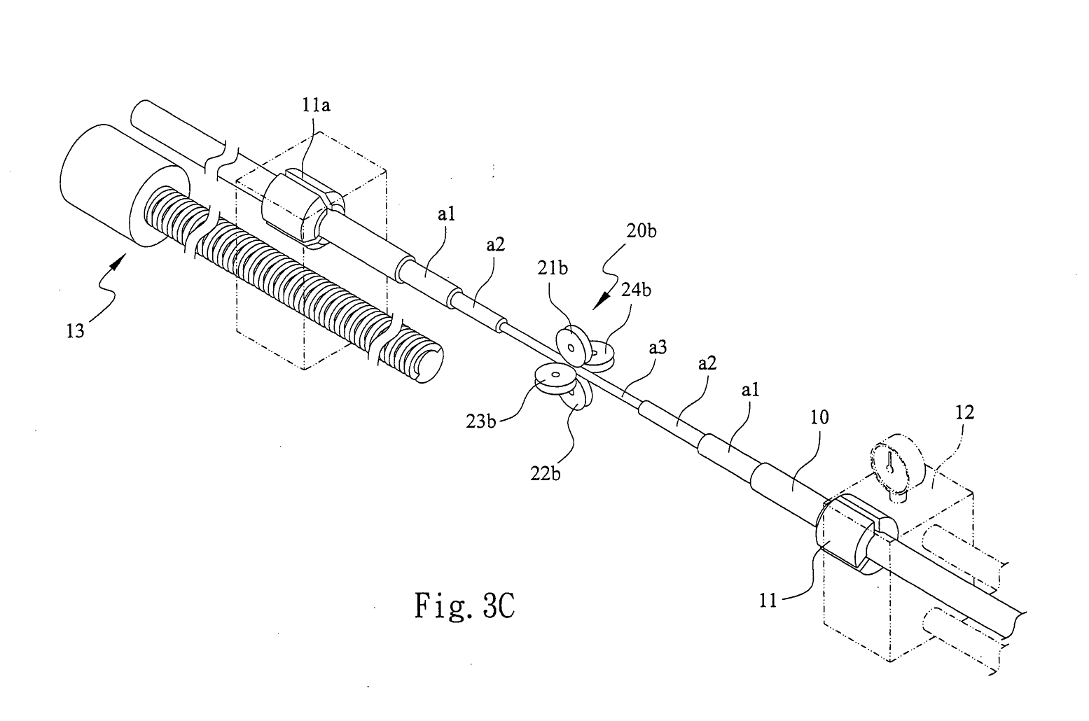

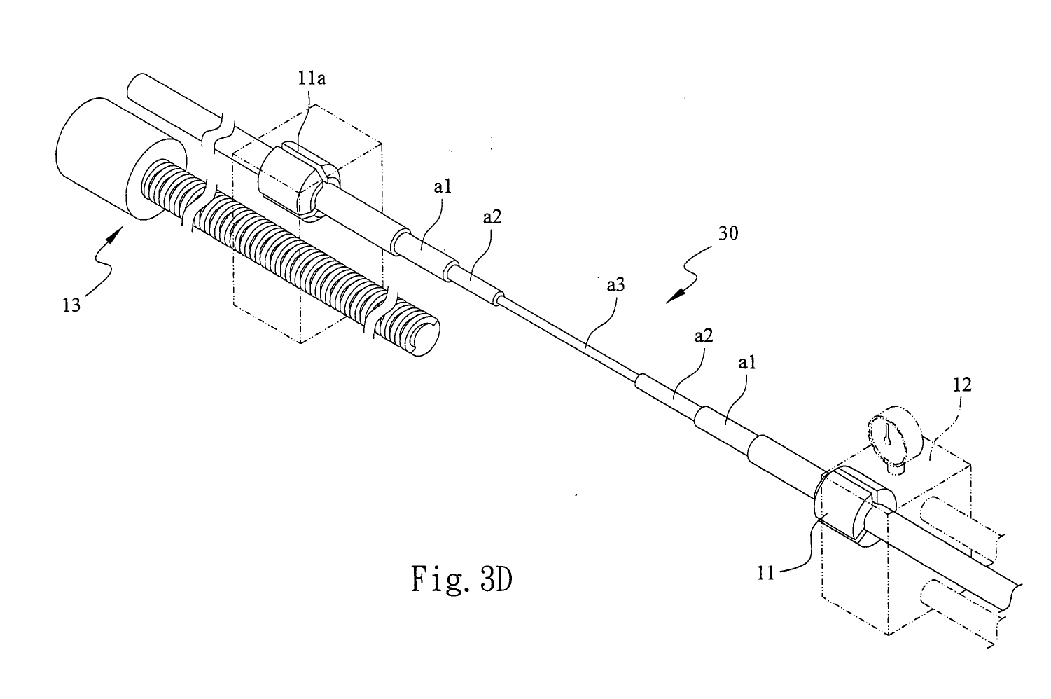

According to a first embodiment of the present invention, referring to FIGS. 3A, 3B, 3C and 3D, as an example, a wire 10 with an original diameter 2.3 mm is processed to be a spoke with diverse diameters of 2.3 mm/2.0 mm/1.8 mm/1.6 mm/1.8 mm/2.0 mm/2.3 mm in sequence. An upper wheel 21 and a lower wheel 22 of a first roller 20 press the wire 10 to form oval cross section, and subsequently release the wire 10. A left wheel 23 and a right wheel 24 of the first roller 20 press the wire 10 to form a first layer a1 of diameter 2.0 mm, as shown in FIG. 3A, and subsequently releasing the wire 10. An upper wheel 21a and a lower wheel 22a of a second roller 20a press the first layer a1 of the wire 10 to form oval cross section, and subsequently release the wire 10. A left wheel 23a and a right wheel 24a of the second roller 20a press the first layer a1 of the wire 10 to form a second layer a2 of diameter 1.8 mm, as shown in FIG. 3B, and subsequently releasing the wire 10. An upper wheel 21b and a lower wheel 22b of a third roller 20b press the second layer a2 of the wire 10 to form oval cross section, and subsequently release the second layer a2 of the wire 10. A left wheel 23b and a right wheel 24b of the third roller 20b press the second layer a2 of the wire 10 to form a third layer a3 of diameter 1.6 mm, as shown in FIG. 3C. Consequently, as shown in FIG. 3D, a spoke 30 with diverse diameters of 2.3 mm/2.0 mm/1.8 mm/1.6 mm/1.8 mm/2.0 mm/2.3 mm in sequence is acquired. During the wire 10 is pressed, the load meter 12 on the clamp 11 maintains the wire 10 under strain of fixed tension, avoiding the wire 10 deviate from the first roller 20, the second roller 20a or the third roller 20b. The controlling device 13 on the second clamp 11a controls starting point and ending point of pressing, where the controlling device 13 serves as a reference starting point during pressing.

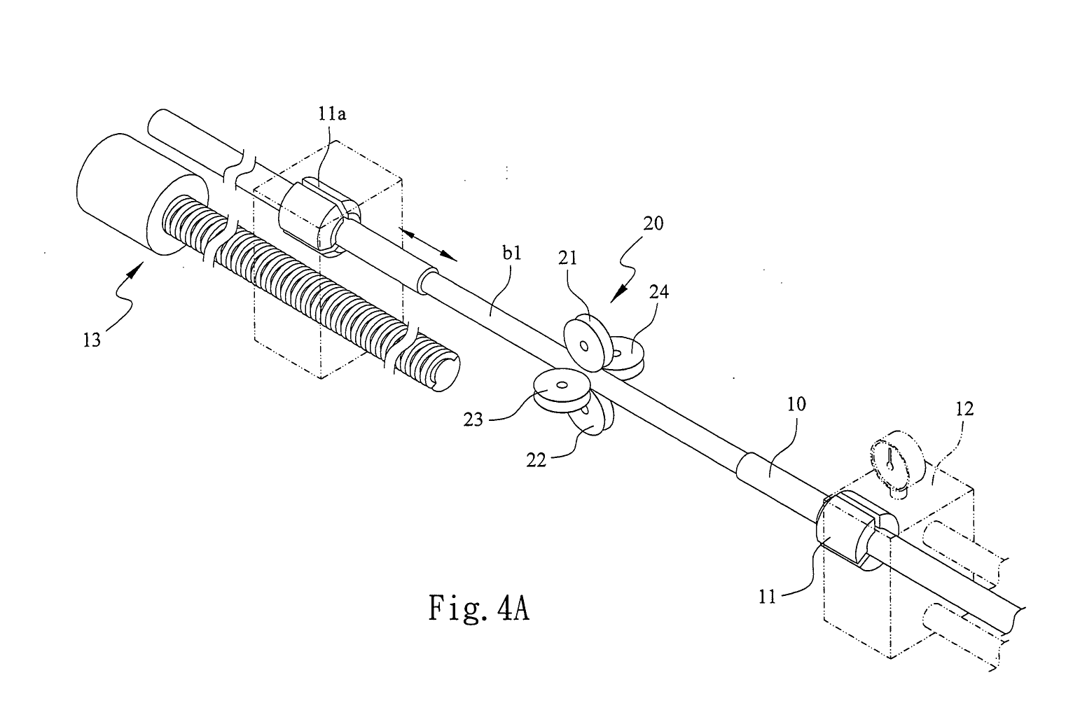

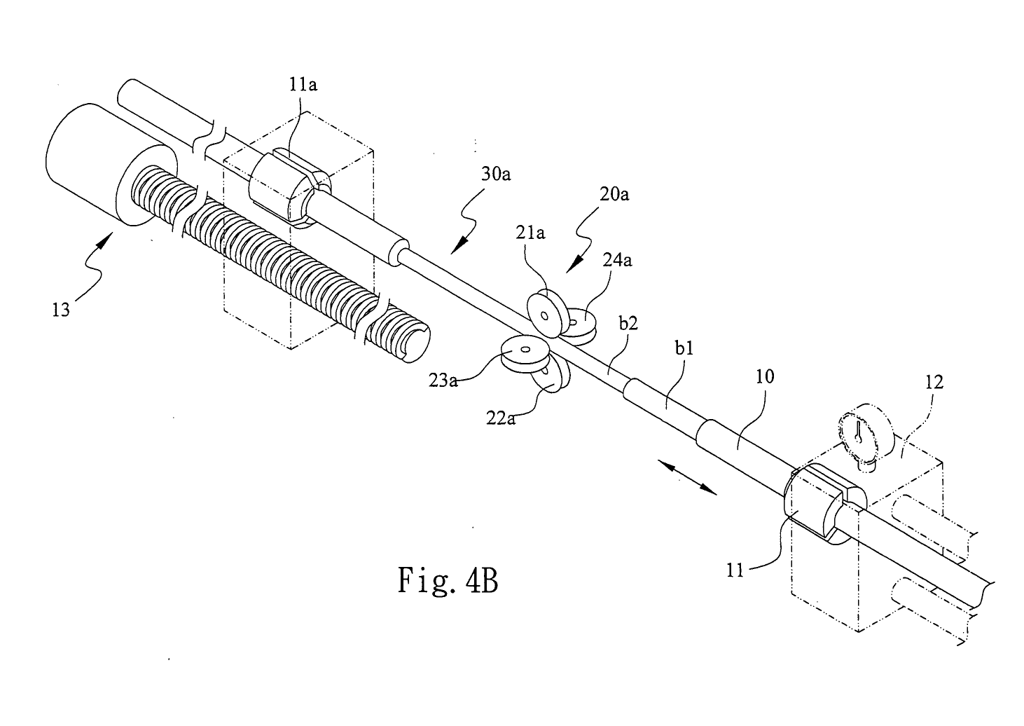

According to a second embodiment of the present invention, referring to FIGS. 4A and 4B, as an example, a wire 10 with an original diameter 2.3 mm is processed to be a spoke with diverse diameters of 2.3 mm/1.6 mm/2.0 mm/2.3 mm in sequence. The upper wheel 21 and the lower wheel 22 of the first roller 20 press the wire 10 to form oval cross section, and subsequently release the wire 10. The left wheel 23 and the right wheel 24 of the first roller 20 press the wire 10 to form a first layer b1 of diameter 2.0 mm, as shown in FIG. 4A, and subsequently releasing the wire 10. The upper wheel 21a and the lower wheel 22a of the second roller 20a press the first layer b1 of the wire 10 to form oval cross section, and subsequently release the wire 10. The left wheel 23a and the right wheel 24a of the second roller 20a press the first layer a1 of the wire 10 to form a second layer b2 of diameter 1.6 mm, as shown in FIG. 4B. A predetermined portion of the second layer b2 remains unprocessed. Consequently, a spoke 30a with diverse diameters of 2.3 mm/1.6 mm/2.0 mm/2.3 mm in sequence is acquired. During the wire 10 is pressed, the load meter 12 on the clamp 11 maintains the wire 10 under strain of fixed tension, avoiding the wire 10 deviate from the first roller 20 or the second roller 20a. The controlling device 13 on the second clamp 11a controls starting point and ending point of pressing process, where the controlling device 13 serves as a reference starting point during pressing.

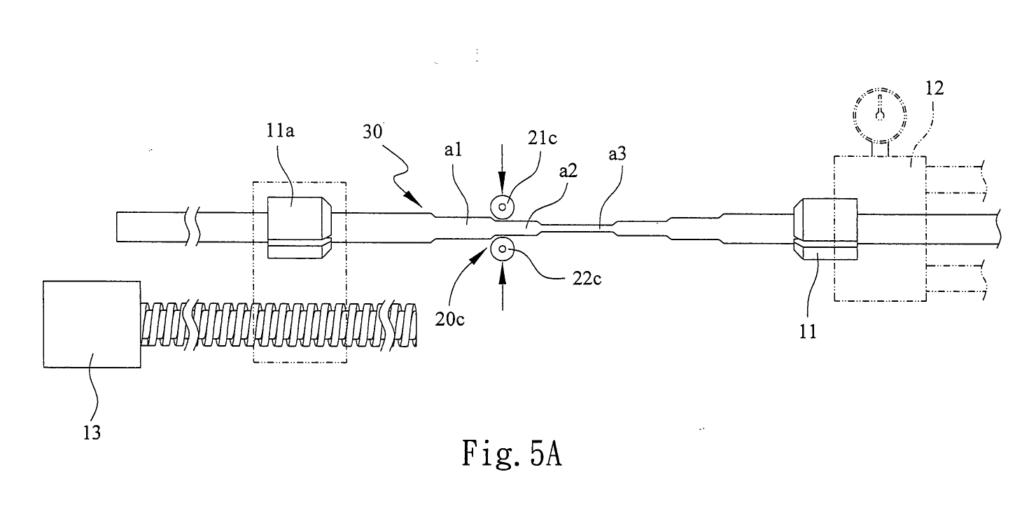

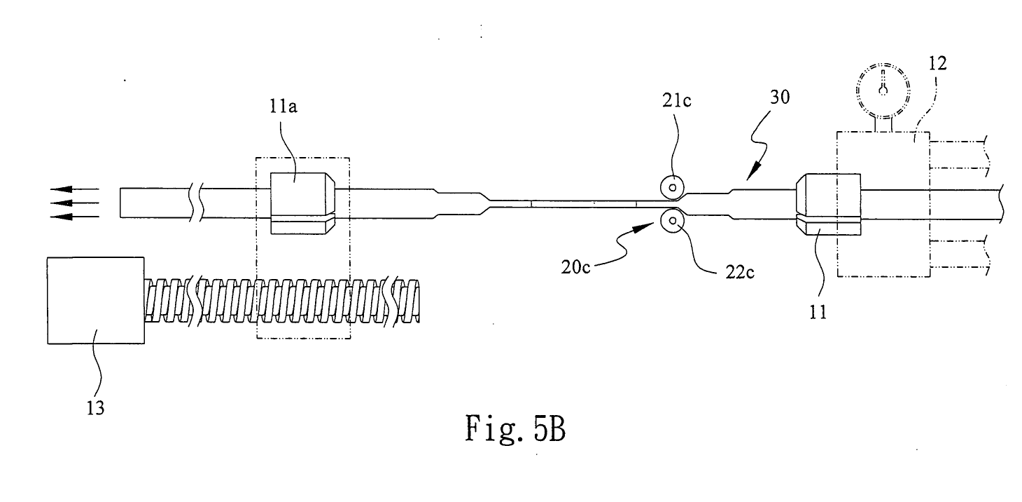

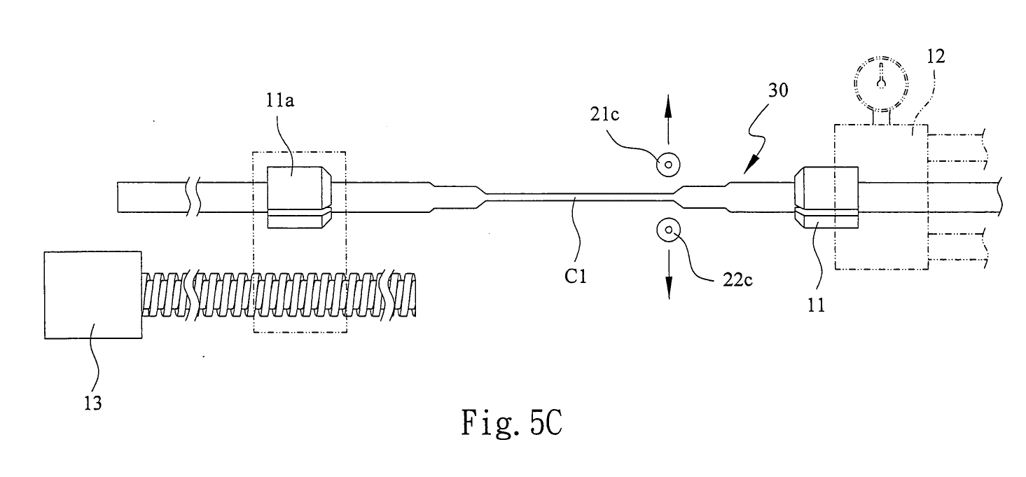

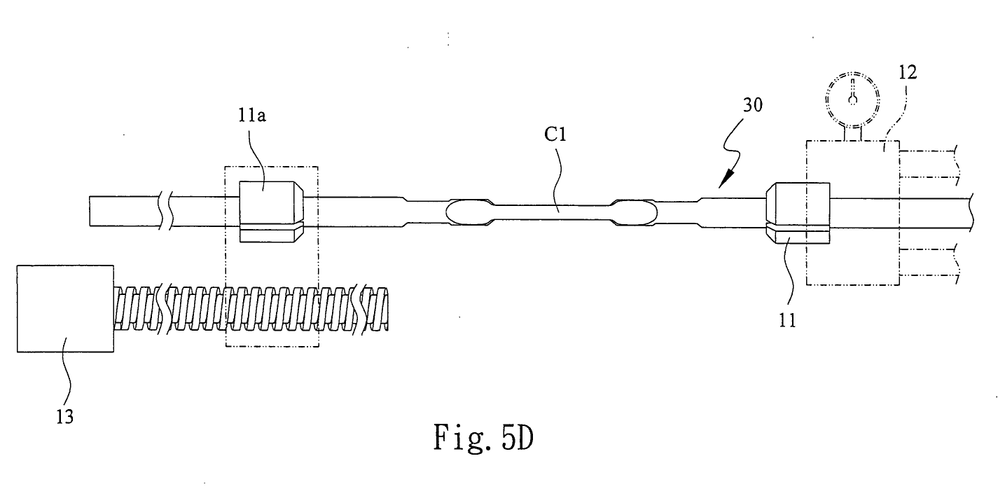

According to a third embodiment of the present invention, FIGS. 5A, 5B, 5C and 5D exemplary illustrate that, the spoke 30 in FIG. 3D is processed to form flat cross section on the second layer a2 and the third layer a3. An upper wheel 21c and a lower wheel 22c (or a left wheel 23c and a right wheel 24c) of a fourth roller 20c press the second layer a2 and the third layer a3 of the spoke 30 to form flat cross section of width c1.

In another embodiment, the upper wheel 21 and the lower wheel 22 (or the left wheel 23 and the right wheel 24) of the first roller 20 press a wire 10 to form flat cross section. During the wire 10 is pressed, the load meter 12 on the clamp 11 maintains the wire 10 under strain of fixed tension, avoiding the wire 10 deviate from the first roller 20. The controlling device 13 on the second clamp 11a controls starting point and ending point of pressing, where the controlling device 13 serves as a reference starting point during pressing.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A method for manufacturing a spoke with diverse diameters comprising following steps:
a) placing a wire: a first clamp and a second clamp respectively positioning ends of a wire and exerting appropriate tension to the wire for allowing the wire to extend freely, a load meter being provided on the first clamp for sustaining the wire under strain of fixed tension, a controlling device being provided on the second clamp for controlling starting point and ending point of pressing;
b) pressing for shaping: at least two rollers being provided to move horizontally along the wire and press the wire according to desired diverse diameters to form diverse diameters with circular, oval or flat cross section on the wire; and
c) cutting: the wire being cut in accordance with desired length after pressing.

2. The method for manufacturing a spoke with diverse diameters as claimed in claim 1, wherein the controlling device is a servo motor.

3. The method for manufacturing a spoke with diverse diameters as claimed in claim 1, wherein each roller includes an upper wheel, a lower wheel, a left wheel and a right wheel, and wherein the upper wheel, the lower wheel, the left wheel and the right wheel respectively defines an upper groove, a lower groove, a left groove and a right groove around rims thereof, the upper wheel, the lower wheel, the left wheel and the right wheel adjust distance therebetween to press a wire to form diverse diameters with circular cross section on the wire.

4. The method for manufacturing a spoke with diverse diameters as claimed in claim 3, wherein the upper wheel and the lower wheel, or the left wheel and the right wheel, press a wire to form oval cross section on the wire.

5. The method for manufacturing a spoke with diverse diameters as claimed in claim 3, wherein the upper wheel and the lower wheel of a roller press a wire to form circular cross section, and subsequently press the wire to form flat cross section.

6. The method for manufacturing a spoke with diverse diameters as claimed in claim 3, wherein the left wheel and the right wheel of a roller press a wire to form circular cross section, and subsequently press the wire to form flat cross section.
